(19) United States
(12) Patent Application Publication
(10) Pub. No.: US 2012/0105402 A1
(43) Pub. Date: May 3, 2012

(54) METHOD AND SYSTEM FOR ADJUSTING LIGHT OUTPUT FROM A LIGHT SOURCE

(75) Inventor: Hsin-Chieh HUANG, Hsinchu City (TW)

(73) Assignee: TAIWAN SEMICONDUCTOR MANUFACTURING COMPANY, LTD., Hsinchu (TW)

(21) Appl. No.: 13/084,701

(22) Filed: Apr. 12, 2011

Related U.S. Application Data
(63) Continuation-in-part of application No. 12/912,948, filed on Oct. 27, 2010.

(51) Int. Cl. G06F 3/038; H05B 37/02

(52) U.S. Cl. 345/207; 315/158

(57) ABSTRACT

A light adjusting system, system including a light guide adapted to collect light from a light source. A calibration value for the light source is stored in a memory. A light detector is coupled with the light guide. S controller is electrically connected to an output of the light detector and detachably connected to a driver for driving the light source. The controller is adapted to control the driver responsive to the output of the light detector.

### CROSS-REFERENCE TO RELATED APPLICATIONS

This application is a Continuation-in-Part of U.S. patent application Ser. No. 12/912,948, filed Oct. 27, 2010, entitled “Method and System for Adjusting Light Output from a Light Source”, the application is hereby incorporated herein by reference in their entireties.

### TECHNICAL FIELD

The present disclosure relates generally to a method and system for a portable device that measures and adjusts the output of light-emitting diodes (LEDs).

### BACKGROUND

An LED is a semiconductor based light source including a semiconductor diode and optionally photoluminescent phosphor material, also referred to herein as phosphor, for generating a light at a specified wavelength or a range of wavelengths. LEDs are traditionally used for indicator lamps and are increasingly used for displays, such as liquid-crystal displays (LCDs).

An LED emits light when a voltage is applied across a p-n junction formed by oppositely doped semiconductor compound layers. The wavelength of the light generated by the p-n junction depends on the band gaps of the semiconductor layers used to fabricating an active layer within the p-n junction of the LED. Thus, a specific p-n junction will emit only a narrow band of wavelengths. Additional phosphor materials are included in some LEDs as a coating over the LED. Light generated by the p-n junction that strikes the phosphors is converted up or down by the phosphors to a different wavelength. Thus, in addition to the wavelength of light emitted by the p-n junction, the LED emits other wavelengths from the phosphors. A typical white light LED, for example has a p-n junction that emits blue light. A portion of the blue light is converted to red and green light by the phosphors so that the total light output by the LED appears white.

As the LED is subjected to repeated use, the p-n junction within the LED begins to decay. As a result, over time the light luminance of the LED will drop. Further, the phosphors also decay at different rates with respect to each other and the p-n junction. Thus, the color of an LED with phosphors will also change with time.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a high level functional block diagram of components of a light-adjusting system according to an embodiment.

FIGS. 2 and 3 are high level perspective views of two LCD displays incorporating the light-adjusting system according to an embodiment; and

FIG. 4 is a flowchart of a method of using the system of FIG. 1 according to an embodiment.

### DETAILED DESCRIPTION

It is understood that the following disclosure provides many different embodiments, or examples, for implementing different features of the present disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Various embodiments of the present disclosure pertain to a system that detects and adjusts the light output of an electrical device that has light source. Some embodiments of the present disclosure include a hand-held, portable device.

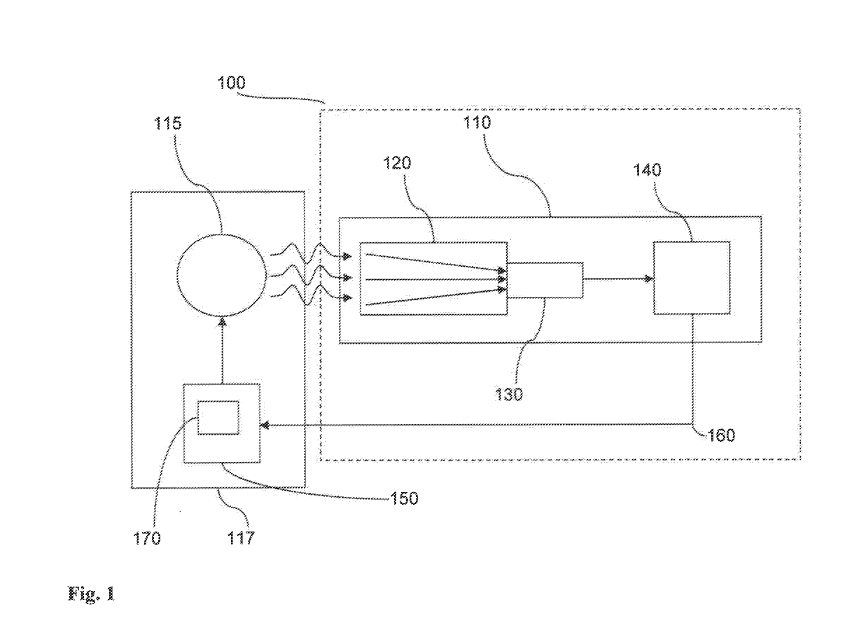

FIG. 1 is a diagram of a light-adjusting system 100. The light-adjusting system 100 comprises a portable light-detecting portion 110. This portable light-detecting portion 110 is designed to measure and detect the luminous intensity value of light output from a light source 115 of an electrical device 117. The electrical device 117 may include the light source 115, a driver 150 and a memory 170. The light source 115 may include an LED or an organic light-emitting diode (OLED). The portable light-detecting portion 110 includes a light collecting and guiding portion 120 and a light detector 130. The light collecting and guiding portion 120 collects the light output from the light source 115 at a particular location of a target electrical device, for example, the display screen of a liquid crystal display. The light collecting and guiding portion 120 guides the light to the light detector 130. In various embodiments, the light collecting and guiding portion 120 is a known light guiding mechanism such as an optical fiber, a light pipe, a covered trench in a substrate. In various embodiments, the light detector 130 detects various light output properties, such as luminous intensity, luminance, color, correlated color temperature or spectral distribution either separately or simultaneously. Luminance is a measure (in candelas per square metre) of the brightness of a point on a surface that is radiating or reflecting light. It is the luminous intensity in a given direction of a small element of surface area divided by the orthogonal projection of this area onto a plane at right angles to the direction. Correlated color temperature (CCT) defines a color as the temperature in degrees Kelvin that a “black body” source must reach in order to produce that same color. CCT describes the dominant color without regard to Human visual response or the source technology and is more appropriate for comparison of visual effectiveness at lower light levels and among different technologies.

The light detector 130 includes a photo sensor or photometer. In various embodiments, the photo sensor is a charge-coupled device, a complementary metal oxide semiconductor (CMOS) sensor, a phototransistor, a photoresister, a photovoltaic cell such as a solar cell or an LED configured to operate as a light detector. In some embodiments, a single collecting and guiding portion 120 is connected to a single light detector 130. In some embodiments, more than one light collecting and guiding portion 120 is connected to a single light detector 130. In some embodiments, light collecting and guiding portion 120 is connected to more than one light detector 130. A controller 140 is connected to the light detector 130. Light output information detected by the light detector 130 is sent to the controller 140.

The controller 140 analyzes the light output information and controls the driver 150 that controls the power or the current being supplied to the light source 115. In some embodiments, the controller 140 increases the power or the current supplied to the light source 115 by the driver 150 if the measured light luminance is lower than a predetermined value. The controller 140 decreases the power or the current supplied to the light source 115 by the driver 150 if the measured light luminance is greater than the predetermined value. Thus, the light output by the light source 115 substantially matches the predetermined threshold value when controlled by the controller 140.

In some embodiments, the controller 140 controls the color output by the light source 115 to be a predetermined color value rather than a predetermined luminance. For example, if the light source comprises red, green and blue LEDs, the ratios of power or the current supplied to each color LED is adjusted separately by the controller 140 using the driver 150. Thus, the color of the output light is adjusted to substantially match the predetermined color value.

The light-adjusting system 100 further comprises a connection 160. The connection 160 connects the driver 150 is to the controller 140. Based on instructions received from the controller 140, the driver 150 adjusts the electrical power or current supplied to the light source 115. One example of such light a source would be an LED of an LED backlighting plate in an LCD display device.

In some embodiments, the light source 115 is an LED. In some embodiments, the light source 115 is an incandescent bulb, a florescent tube, compact florescent bulb, electroluminescent emitter, cold cathode fluorescent lamp or an organic LED. In other embodiments the light source 115 is any combination of one or more of the above light sources.

In one embodiment, the driver 150 is part of electrical device 117. In some embodiments, the driver 150 is external to the electrical device 117.

In one embodiment, the driver 150 includes a memory 170 that stores a calibration value for the power and the current for the light source 115 that is determined by the controller 140. If the controller 140 is controlling the driver 150, the controller updates the memory 170 with new values based on the controlled power or current supplied to the light source 115. If the driver 150 is disconnected from the controller 140, the driver 150 will continue to supply the correct power or current to the light source 115 based on the values stored in the memory 170. In some embodiments, the memory 170 is not included in the driver 150. The driver 150 accesses the information in the memory 170 through a wire transmission or a wireless transmission. In some embodiments, the memory 170 is a part of the light-adjusting system 100.

In some embodiments, the controller 140 is placed in the driver 150 rather than the portable light-detecting portion 110. Further, the connection 160 sends the signal output from the light detector 130 to the controller 140. If the light detector 130 is connected to the controller 140 and the controller is controlling the driver 150, the controller updates the memory 170 with new values based on the controlled power or current supplied to the light source 115. If the controller 140 is disconnected from the light detector 130, the driver 150 continues to supply the correct power or current to the light source 115 based on the values stored in the memory 170.

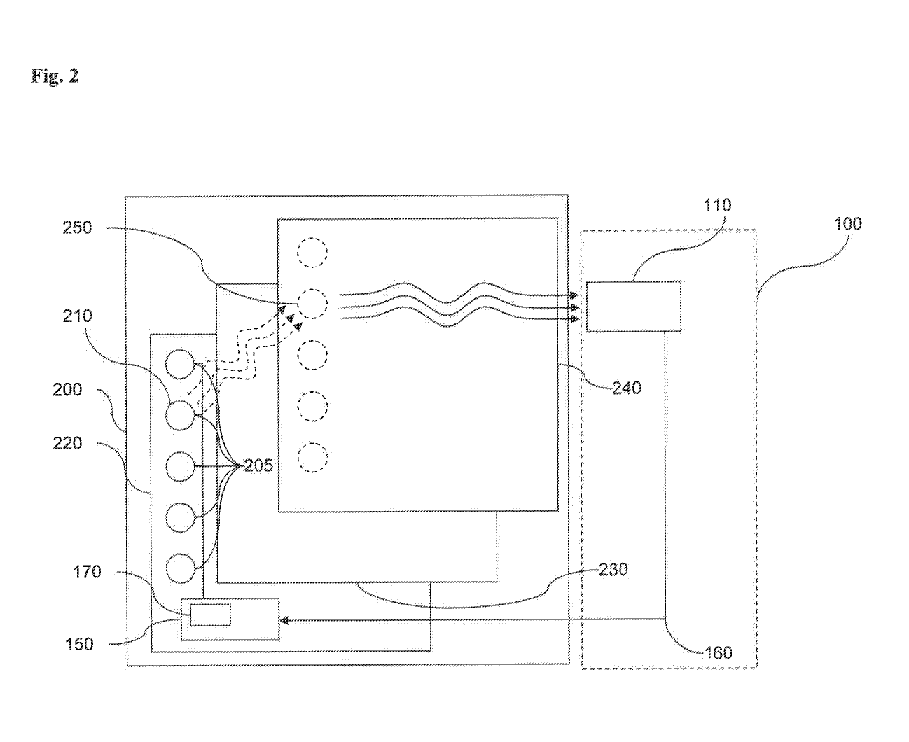

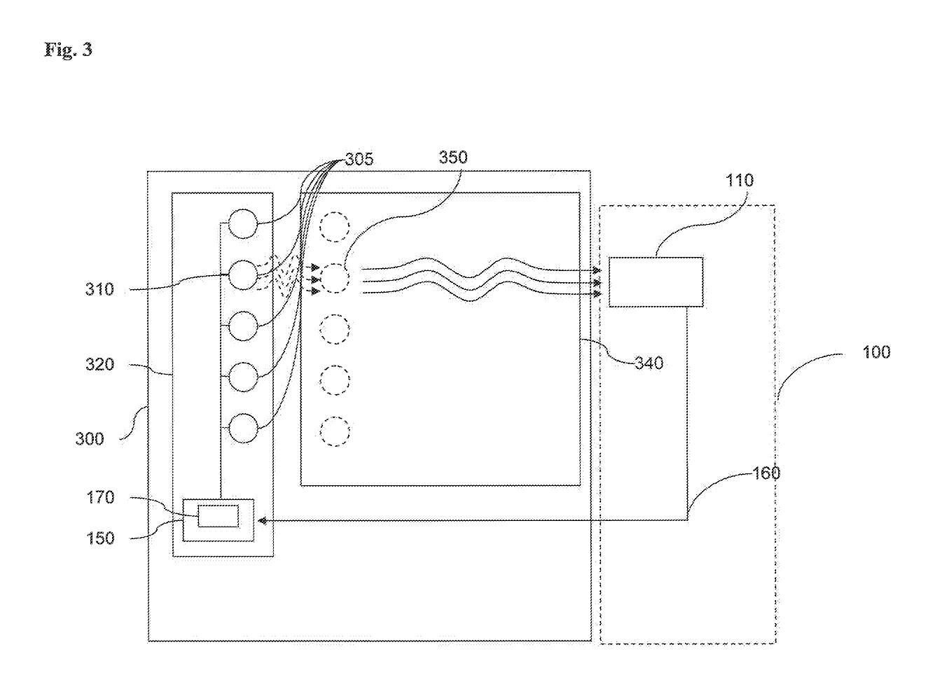

FIGS. 2 and 3 are high level perspective views of the light-adjusting system 100 used to adjust a backlight output of LCD display devices 200 and 300 respectively. The light-adjusting system 100 comprises a portable light-detecting portion 110 as shown in FIG. 1. The portable light-detecting portion 110 includes a light collecting and guiding portion 120, a light detector 130 and a controller 140 as shown in FIG. 1. Light output information detected by the light detector 130 is sent to the controller 140. LCD display devices 200 and 300 are LCD display panels that use LEDs as light sources for backlighting.

With regard to FIG. 2, LCD display device 200 is an LCD display panel with direct-type LED backlighting. In an LCD display device 200 with direct-type LED backlighting, LEDs 205 are distributed on an LED backlighting panel 220. The LED backlighting panel 220 is positioned behind an LCD display panel, such as display panel 240. When the LCD display device 200, such as, for example, an LCD television, is turned on, the LEDs on the LED backlighting panel 220 create backlighting and the backlight is visible by a viewer from the front on the display panel 240. There are several other panels placed between the LED backlighting panel 220 and the LCD display panel 240, such as a diffuser plate 230.

The portable light-detecting portion 110 is used to measure the LED light output in one area of the display surface for example area 250 of the LCD display panel 240. The portable light-detecting portion 110 measures at least a portion of the surface of the display panel 240. In an embodiment, portable light-detecting portion 110 to measures a specific area of the display surface that correlates to a particular light source. The portion of the display surface that most accurately reflects the light output of a particular LED is the portion of the surface of LCD display panel 240 that is directly in front of that LED. The LED 210 correlates with area 250.

In some embodiments, the portable light-detecting portion 110 is not required to be in direct physical contact with the target portion of the LCD display panel surface 240 and only needs to be sufficiently close to the target surface so that the light-output is detected and accurately measured.

In this embodiment, the driver 150 is a part of the LED display device 200. The portable light-detecting portion 110 is connected to the driver 150 in the LCD display device 200 via the connection 160. In some embodiments, the driver 150 is external to the LCD display device 200. In some embodiments, the connection 160 is an electrical or optical transmission line, for example an electrical cable, a fiber optic cable or a light guide. In some embodiments, the connection 160 is a wireless connection, for example a radio link or an infrared link, BLUETOOTH link or short-range wireless. To calibrate the light output of LED 210, the portable light-detecting portion 110 measures the light output by the LED 210 at area 250. Based on the measured light output, the portable light-detecting portion 110 instructs the driver 150 to adjust an amount of electrical power or current or voltage to the corresponding LED 210 in the backlighting panel 220 of the LCD display device 200.

The above measurement and adjustment continues until the light measured at area 250 reaches a predetermined value stored in the driver 150 of the LED display device 200. In one embodiment, the driver 150 includes a memory 170. The driver 150 stores a calibration value for the LED 210 in the memory 170 based on electrical power required to produce the predetermined value. The stored calibration value for the LED 210 is used to calibrate the light output of LED 210 against other LEDs 205 in the backlighting panel 220 when the portable light-detecting portion 110 is not controlling the LED 210. In some embodiments, the memory 170 is not included in the driver 150 and is external to the LCD display device 200. The driver 150 accesses the information in the memory 170 through a wire transmission or a wireless transmission. In some embodiments, the memory 170 is a part of the light-adjusting system 100.

In the same manner, each of the LEDs 205 in the backlighting panel 220 are calibrated by the light-adjusting system 100, and a corresponding calibration value for each LED is stored in the memory 170.

In some embodiments, the predetermined value is a preset value, for example a factory setting. The use of light-adjusting system 100 on the LCD display device 200 with a preset factory value adjusts each LED to output a luminance or CCT that substantially matches the original factory value. Thus, in some cases an old display is adjusted to be as bright as a new display. In some embodiments, the predetermined value is set to be the light luminance measured one of the LEDs 205 in the display device 200. Thus, in some embodiments, all of the LEDs in the display device 200 will be adjusted to be as bright as the one LED, and the display device 200 has uniform brightness. In some embodiments, the predetermined value is set to be the light luminance measured for one of the LEDs 205 in a first display device 200. The light-adjusting system 100 is then used to calibrate a second display device 200. Thus, all of the LEDs in the second display device are adjusted to be as bright as the first display device 200, and the display devices have uniform brightness.

FIG. 3 is an edge-type LED backlighting LCD display device 300 in conjunction with which light-adjusting system 100 is used. Unlike panels with direct-type LED backlighting (in which LEDs are placed on a panel behind the display panel), display panels with edge-type LED backlighting comprise LEDs placed on one or more elongated bars that are positioned on the edges of the display panel.

LCD display device 300 has a number of LEDs 305 that are placed on an elongated LED light bar 320. In some embodiments, the LED light bar 320 is placed on the left side of the display panel 340. Display panels with edge-type LED backlighting are not limited to this particular configuration. In various embodiments, LED light bars 320 are placed at the left, the right, the top, the bottom or any combination of the left, the right, the top or the bottom edges of the display panel 340. In various embodiments, more than one LED light bar 320 is placed on an edge of the display panel 340.

The light-adjusting system 100 comprises a portable light-detecting portion 110. The portable light-detecting portion 110 includes a light collecting and guiding portion 120, a light detector 130 and a controller 140 as shown in FIG. 1. Light output information detected by the light detector 130 is sent to the controller 140. In this embodiment, a driver 150 is a part of the LCD display device 300. The portable light-detecting portion 110 is connected to the driver 150 in the LCD display device 300 via the connection 160. In some embodiments, the connection 160 is an electrical or optical transmission line. In some embodiments, the connection 160 is a wireless connection. To calibrate the light output of LED 305, the portable light-detecting portion 110 measures the light output by the LED 310 at area 350. In some embodiments, the driver 150 is external to the LCD display device 300.

Based on the measured light output, the portable light-detecting portion 110 instructs the driver 150 to adjust an amount of electrical power or current or voltage to the corresponding LED 310 in the LED light bar 320 of the LCD display device 300. The above measurement and adjustment continues until the light measured at area 350 reaches a predetermined value. In at least one embodiment, the driver 150 includes a memory 170. The driver 150 stores a calibration value for the LED 310 in the memory 170 based on electrical power or current or voltage required to produce the predetermined value. The stored calibration value for the LED 310 is used to calibrate the light output of LED 310 with other LEDs in the LED light bar 320 when the portable light-detecting portion 110 is not controlling the LED 310. In some embodiments, the memory 170 is not included in the driver 150 and is external to the LCD display device 300. The driver 150 accesses the information in the memory 170 through a wire transmission or a wireless transmission. In some embodiments, the memory 170 is a part of the light-adjusting system 100.

In the same manner, in some embodiments, all of the LEDs 305 in the LED light bars 320 are calibrated by the light-adjusting system 100, and a corresponding calibration value for each LED stored in the memory 170.

In various embodiments, the predetermined value is set using one or more of the methods described in relation to FIG. 2.

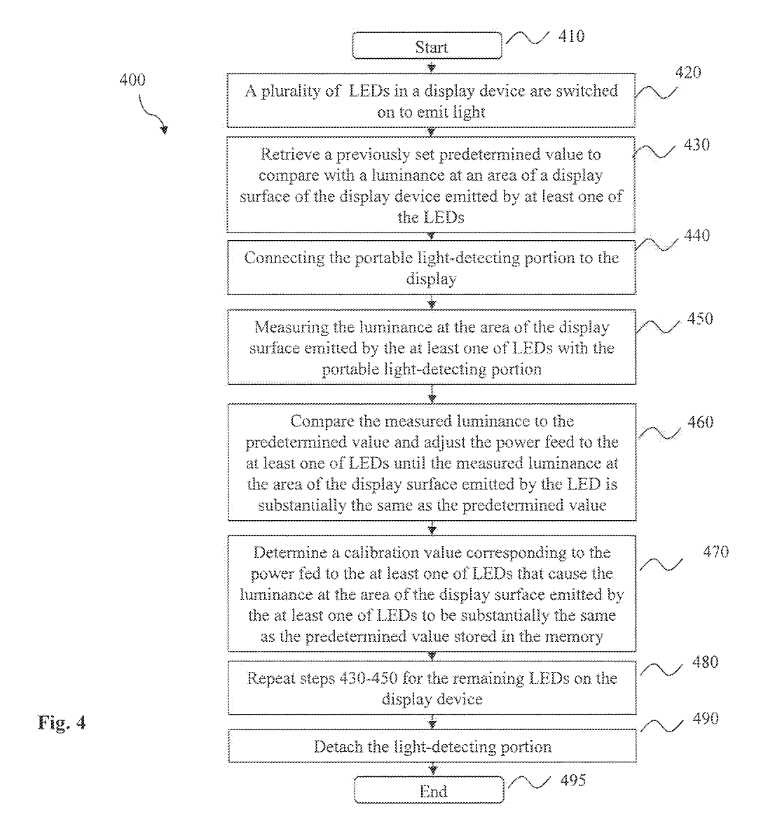

FIG. 4 is a method 400 of calibrating the LCD display devices of FIGS. 2 and 3 using the light-adjusting system 100. The method begins at step 410 and proceeds to step 420.

In step 420, a plurality of LEDs 205 or 305 in the LED-backlighting panel 220 or LED light bar 320 of a display device are switched on to emit light. The display device comprises a display surface having a plurality of portions. Next, the method proceeds to step 430.

At step 430, a previously set predetermined value is retrieved. In one embodiment, the predetermined value is based on a measured value of a light output at a predetermined portion of the display surface. The predetermined value is used at step 460 to compare with a luminance or CCT at an area of the display surface emitted by at least one of the LEDs, for example LED 210 or 310, measured by the portable light-detecting portion 110. The predetermined value is stored in a memory 170. In another embodiment, the predetermined value is based on a measured value of a light output at a display surface of a different display device. Next, the method proceeds to step 440.

At step 440, the portable light-detecting portion 110 is connected to the LCD display device 200 or 300 by the connection 160. Next, the method proceeds to step 450.

At step 450, the luminance or CCT at the area of the display surface is measured by the portable light-detecting portion 110 at the area 250 or 350 corresponding to the LED 210 or 310. Upon completion of the measurement the method proceeds to step 460.

At step 460, the measured luminance or CCT at the area of the display surface emitted by the at least one of LEDs (ex. LED 210 or 310) is compared to the predetermined value. The power or current fed to the at least one of LEDs is adjusted by driver 150 until the measured luminance or CCT at the area of the display surface substantially matches the predetermined value. Upon completion of the adjustment the method proceeds to step 470.

At step 470, the power or current fed to the LED 210 or 310 that causes the luminance or CCT at the area of the display surface to match substantially the predetermined value is stored as a calibration value in the memory 170. After storing the calibration value the method proceeds to step 480.

At step 480, the steps 430-450 are repeated for the remaining LEDs on the display device 200 or 300. Upon completion of steps 430-450 for all of the LEDs the method proceeds to step 490.

At step 490, the portable light-detecting portion 110 is disconnected from the LCD display device 200 or 300. The method proceeds to step 495 where the method terminates.

Embodiments of the disclosure are applicable to LCD display devices, display such as plasma displays, direct LED displays in which each pixel is an LED or organic LED display. Further, embodiments of the disclosure are applicable to warn an operator of a safety issue. LEDs are used for lighting and warning applications in, for example, cars, airplanes and trains. The system and method are applicable to measuring LED light luminance as detected on an exterior of a vehicle. For example, the system and method are applicable to measuring LED light luminance on the surface of a headlight casing for a car, comparing the measured light intensities to a specified baseline. The operator is warned if the measured light intensities are below the specified baseline, and the light output of the LEDs corrected to a required safe level.

The foregoing has outlined features of several embodiments. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A light adjusting system comprising:
a light guide adapted to collect light from a light source, wherein a calibration value for the light source is stored in a memory;
a light detector coupled with the light guide; and
a controller electrically connected to an output of the light detector and detachably connected to a driver for driving the light source, the controller being adapted to control the driver responsive to the output of the light detector.

2. The system of claim 1, wherein the light source is an LED.

3. The system of claim 1, wherein the driver is connected to the controller a via wired connection.

4. The system of claim 1, wherein the driver is connected to the controller via a wireless connection.

5. The system of claim 1, wherein the driver comprises the memory.

6. The system of claim 1, wherein the controller is adapted to compare collected light from the light source and the calibration value for the light source stored in the memory.

7. The system of claim 1, wherein the driver is adapted to adjust a luminance or correlated color temperature (CCT) of the light source.

8. The system of claim 1, wherein the light detector is at least one of a charge-coupled device or a complementary metal oxide semiconductor (CMOS) sensor.

9. The system of claim 1, wherein the memory is a part of the light adjusting system.

10. A display system comprising:
a display device comprising:
at least one LED; and
at least one driver for driving the at least one LED;
a light guide adapted to collect light from the at least one LED;
a light detector attached to the light guide;
a memory adapted to store a calibration value for the at least one LED; and
a controller electrically connected to an output of the light detector and detachably connected to an input of the at least one driver.

11. The display system of claim 10, wherein the at least one driver is connected to the controller via a wired connection.

12. The display system of claim 10, wherein the at least one driver is connected to the controller via a wireless connection.

13. The display system of claim 10, wherein the controller is adapted to compare the collected light from the at least one LED and the calibration value for the LED stored in the memory.

14. The display system of claim 10, wherein the controller is adapted to control the at least one driver responsive to the output of the light detector.

15. The display system of claim 10, wherein the memory is external to the display device.

16. A method comprising:
measuring a light output at a display surface of a display device, the display device comprising a light source producing the light output;
retrieving a predetermined value of the display device;
comparing the measured light output to the predetermined value; and
adjusting the light source in the display device so that the measured light output substantially matches the predetermined value.

17. The method of claim 16, wherein the predetermined value is a preset value for the display device.

18. The method of claim 16, wherein the predetermined value is based on a measured value of a light output at a predetermined portion of the display surface.

19. The method of claim 16, wherein the predetermined value is based on a measured value of a light output at a display surface of a different display device.

20. The method of claim 16, the method further comprising attaching a portable light-detecting portion for measuring the light output of the display surface before measuring the light output of the display surface and detaching the portable light-detecting portion after storing a calibration.
